(19) United States
(12) Patent Application Publication
(10) Pub. No.: US 2024/0288537 A1
(43) Pub. Date: Aug. 29, 2024

(54) RADAR APPARATUS, SIGNAL PROCESSING CIRCUIT, AND SIGNAL PROCESSING METHOD FOR RADAR APPARATUS

(71) Applicant: RichWave Technology Corp., Taipei (TW)

(72) Inventor: Hsiang-Feng Chi, Taipei (TW)

(73) Assignee: RichWave Technology Corp., Taipei (TW)

(21) Appl. No.: 18/501,015

(22) Filed: Nov. 2, 2023

(30) Foreign Application Priority Data
Nov. 21, 2022 (TW) 111144404

(51) Int. Cl. G01S 7/32; G01S 13/34

(52) U.S. Cl. CPC G01S 7/32; G01S 13/343; G01S 13/345

(57) ABSTRACT

The disclosure provides a radar apparatus, a signal processing circuit, and a signal processing method for radar apparatus. The radar apparatus includes a frequency synthesizer, a signal generator, and a transmitting front-end circuit. The frequency synthesizer generates a carrier signal. A frequency of the carrier signal changes with time within a sweep period of the carrier signal, and the carrier signal includes a frequency raising section and a frequency decreasing section. The signal generator generates a shaping signal. The shaping signal includes two sections. The two sections have different amplitudes. One of the two sections corresponds to a turn-around section between the frequency raising section and the frequency decreasing section. The transmitting front-end circuit is coupled to the frequency synthesizer and the signal generator and generates a transmitting signal according to the carrier signal and the shaping signal. In this way, the spurious peak on the spectrum is reduced.

### CROSS-REFERENCE TO RELATED APPLICATION

This application claims the priority benefit of Taiwan application serial no. 111144404, filed on Nov. 21, 2022. The entirety of the above-mentioned patent application is hereby incorporated by reference herein and made a part of this specification.

### BACKGROUND

### Technical Field

The disclosure relates to a radar technology, and more particularly, to a radar apparatus, a signal processing circuit, and a signal processing method for radar apparatus.

### Description of Related Art

FIG. 1 is a schematic diagram of a circuit of conventional frequency modulation continuous wave (FMCW) radar. Referring to FIG. 1, a carrier signal x(t) generated by a frequency synthesizer FS (e.g., triangle wave or sawtooth wave carrier sweep) is amplified by an amplifier PA, and then the amplified signal is emitted through an antenna TX. On the other hand, an echo signal is received by a receiving antenna RX and amplified by a low noise amplifier (LNA), and then the amplified signal and the carrier signal x(t) are mixed by a mixer MIX to determine the existence, the distance, and/or the velocity. It is worth noting that some applications (e.g., ultra wideband (UWB)) have specifications for transmission power. However, in order to realize the triangle wave or sawtooth wave carrier frequency sweeping, conventional radar may exceed the specification for transmission power. If the transmission power is reduced to comply with the specification, the sensing range of the radar may be limited.

### SUMMARY

The radar apparatus of the embodiment of the disclosure includes a frequency synthesizer, a signal generator, and a transmitting front-end circuit. The frequency synthesizer is configured to generate a carrier signal. A frequency of the carrier signal changes with time within a sweep period of the carrier signal, and the carrier signal includes a frequency raising section and a frequency decreasing section. The signal generator is configured to generate a shaping signal. The shaping signal includes a first section and a second section. The first section and the second section have different amplitudes. The second section corresponds to a turn-around section between the frequency raising section and the frequency decreasing section. The transmitting front-end circuit is coupled to the frequency synthesizer and the signal generator and configured to generate a transmitting signal according to the carrier signal and the shaping signal.

The signal processing circuit of the embodiment of the disclosure includes a frequency synthesizer and a signal generator. The frequency synthesizer is configured to generate a carrier signal. A frequency of the carrier signal changes with time within a sweep period of the carrier signal, and the carrier signal includes a frequency raising section and a frequency decreasing section. The signal generator is configured to generate a shaping signal. The shaping signal includes a first section and a second section. The first section and the second section have different amplitudes. The second section corresponds to a turn-around section between the frequency raising section and the frequency decreasing section.

On the other hand, the signal processing method for a radar apparatus of the embodiment of the disclosure includes the following process. A carrier signal is generated. A frequency of the carrier signal changes with time within a sweep period of the carrier signal, and the carrier signal includes a frequency raising section and a frequency decreasing section. A shaping signal is generated. The shaping signal includes a first section and a second section. The first section and the second section have different amplitudes. The second section corresponds to a turn-around section between the frequency raising section and the frequency decreasing section. A transmitting signal is generated according to the carrier signal and the shaping signal, the transmitting signal is configured to allow the radar apparatus to emit.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a circuit of conventional frequency modulation continuous wave radar.

FIG. 2 is a block diagram of elements of a radar apparatus according to an embodiment of the disclosure.

FIG. 3A is a schematic diagram of a carrier signal according to an embodiment of the disclosure.

FIG. 3B is a schematic diagram of a carrier signal according to an embodiment of the disclosure.

FIG. 4A is a schematic diagram of a shaping signal for FIG. 3A according to an embodiment of the disclosure.

FIG. 4B is a schematic diagram of a shaping signal for FIG. 3B according to an embodiment of the disclosure.

FIG. 5 is a schematic diagram of a transmitting front-end circuit, an input signal thereof, a frequency synthesizer, and a signal generator according to an embodiment of the disclosure.

FIG. 6A is a schematic diagram of a waveform according to an embodiment of the disclosure.

FIG. 6B is a schematic diagram according to the spectrum of FIG. 6A.

FIG. 7A is a schematic diagram of a waveform according to an embodiment of the disclosure.

FIG. 7B is a schematic diagram according to the spectrum of FIG. 7A.

FIG. 8 is a flowchart of a signal processing method for radar apparatus according to an embodiment of the disclosure.

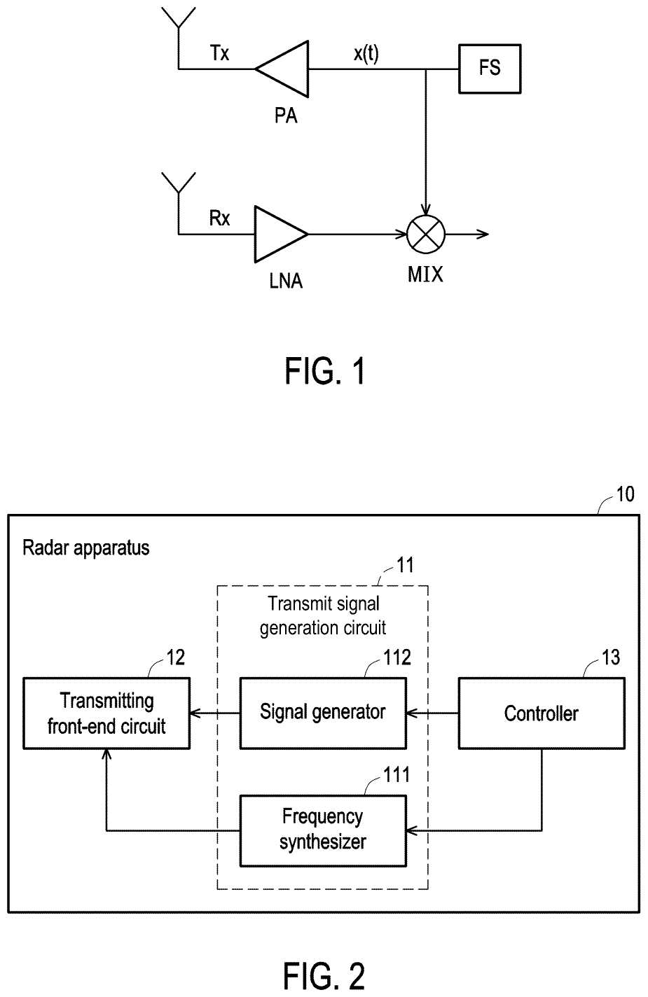

### DESCRIPTION OF THE EMBODIMENTS

FIG. 2 is a block diagram of elements of a radar apparatus 10 according to an embodiment of the disclosure. Referring to FIG. 2, the radar apparatus 10 includes (but not limited to) a signal processing circuit, a transmitting front-end circuit 12, and a controller 13. For example, the radar apparatus 10 is applied to fields such as meteorology, speed measurement, car backing, terrain, and military affairs. The radar apparatus 10 may be a frequency modulated continuous wave (FMCW) radar or an ultra wideband (UWB) radar.

In one embodiment, the signal processing circuit could be a transmit signal generation circuit 11. The transmit signal generation circuit 11 includes a frequency synthesizer 111 and a signal generator 112.

The frequency synthesizer 111 is coupled to the transmitting front-end circuit 12 and the controller 13. The frequency synthesizer 111 is configured to generate a carrier signal. A frequency of the carrier signal changes with time within a sweep period of the carrier signal.

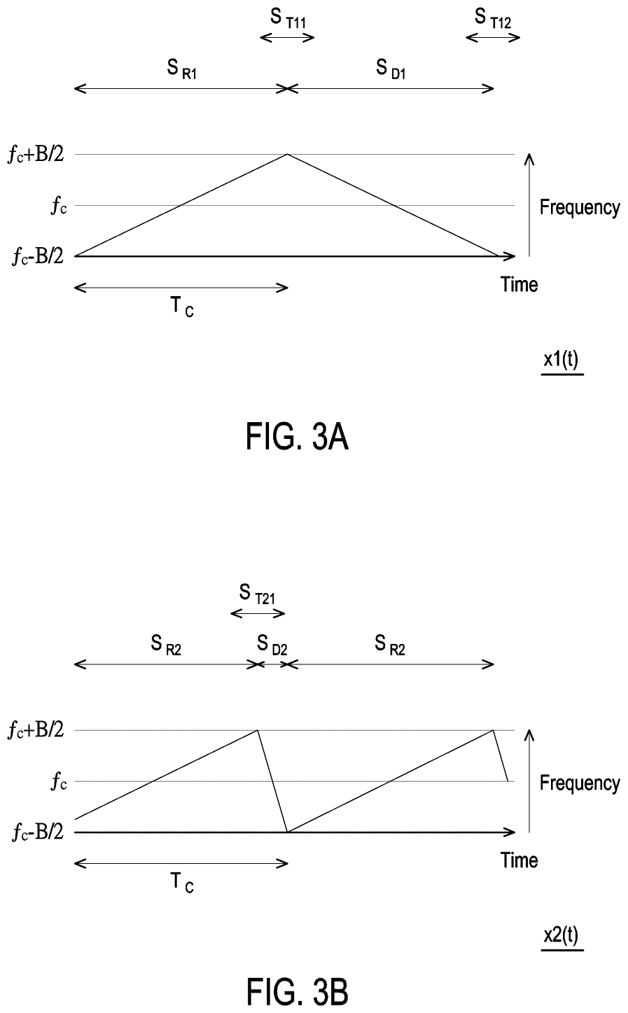

For example, FIG. 3A is a schematic diagram of a carrier signal x1 according to an embodiment of the disclosure. Referring to FIG. 3A, the frequency of the carrier signal x1 is a triangle wave. The frequency of the carrier signal x1 changes between f_{c}−B/2 and f_{c}+B/2 with time t. f_{c} is a carrier frequency, and B is a bandwidth. The frequency of the carrier signal x1 includes a frequency raising section S_{R1} and frequency decreasing section S_{D1} on a timeline. Periods T_{c} of the frequency raising section S_{R1} and the frequency decreasing section S_{D1} are equal. The frequency within the frequency raising section S_{R1} increases with time, while the frequency within the frequency decreasing section S_{D1} decreases with time. In addition, a turn-around section S_{T11} is provided at a junction between the frequency raising section S_{R1} and the frequency decreasing section S_{D1}, and another turn-around section S_{T12} is provided at a junction between the frequency decreasing section S_{D1} and another frequency raising section S_{R1} (not shown in the figure). The turn-around section S_{T11} refers to a section where the frequency rises to the peak of the waveform and then decreases. The turn-around section S_{T12} refers to a section where the frequency rises after decreasing to the valley of the waveform.

FIG. 3B is a schematic diagram of a carrier signal x2 according to an embodiment of the disclosure. The frequency of the carrier signal x2 is sawtooth wave. The frequency of the carrier signal x2 changes between f_{c}−B/2 and f_{c}+B/2 with time t. The frequency of the carrier signal x2 includes a frequency raising section S_{R2} and frequency decreasing section S_{D2} on a timeline. A total period of the frequency raising section S_{R2} and the frequency decreasing section S_{D2} is Tc. The frequency within the frequency raising section S_{R2} increases with time, while the frequency within the frequency decreasing section S_{D2} decreases with time. In addition, a turn-around section S_{T21} is provided at an interval from the frequency raising section S_{R2} to the frequency decreasing section S_{D2}. The turn-around section S_{T21} refers to the section where the frequency rises to the peak of the waveform and then decreases to the valley of the waveform.

It should be noted that the instantaneous frequency of the carrier signal is not limited to sawtooth wave or triangle wave, and the carrier signal may also be other carrier signals applied to frequency modulated continuous wave (FMCW) (e.g., linear, geometric, or other chirp signals).

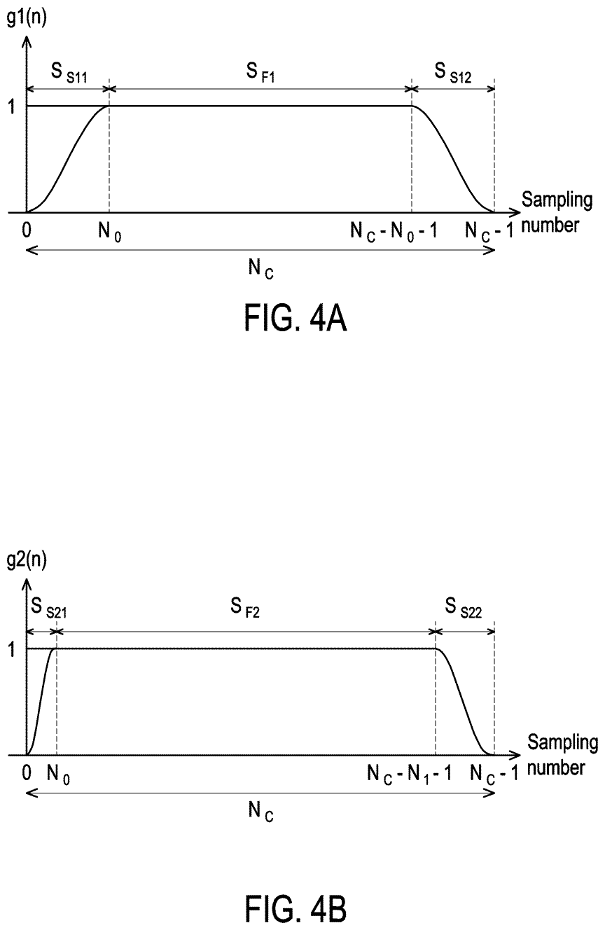

The signal generator 112 is coupled to the transmitting front-end circuit 12 and the controller 13. The signal generator 112 is configured to generate a shaping signal. For example, FIG. 4A is a schematic diagram of a shaping signal g1 for FIG. 3A according to an embodiment of the disclosure. Referring to FIG. 4A, a shaping signal g1(t) (analog form) and a shaping signal g1(n) (discrete-time digital form) includes a section S_{F1}, a section S_{S11}, and a section S_{S12} in the time domain. Cycles of the section S_{F1}, the section S_{S11}, and the section S_{S12} are the same as the periods T_{c} of the frequency raising section S_{R1} or the frequency decreasing section S_{D1} of the carrier signal x1 in FIG. 3A (corresponding to sampling numbers of 0 to N_{c}−1, i.e., a total of N_{c} sampling numbers in the digital signal domain).

The amplitude of the section S_{F1} is different from that of the section S_{S11} and the section S_{S12}. For example, the amplitude is consistent/the same during the section S_{F1} at the time domain, while the amplitudes of the section S_{S11} and the section S_{S12} may change with the time t or the sampling number n. In an embodiment, the amplitudes of the section S_{S11} and the section S_{S12} are smaller than that of the section S_{F1}. For example, in terms of a digital form, the amplitude of the section S_{F1} is 1. The amplitudes of the section S_{S11} and the section S_{S12} is less than 1 and even drops to 0.

FIG. 4B is a schematic diagram of a shaping signal g2 for FIG. 3B according to an embodiment of the disclosure. Referring to FIG. 4A, a shaping signal g2(t) (analog form) and a shaping signal g2(n) (digital form) includes a section S_{F2}, a section S_{S21}, and a section S_{S22} in the time domain. Cycles of the section S_{F2}, the section S_{S21}, and the section S_{S22} are the same as the periods T_{c} of the frequency raising section S_{R2} or the frequency decreasing section S_{D2} of the carrier signal x2 in FIG. 3B (corresponding to sampling numbers of 0 to N_{c}−1, i.e., a total of N_{c} sampling numbers in the digital signal domain).

The amplitude of the section S_{F2} is different from that of the section S_{S21} and the section S_{S22}. For example, the amplitude is consistent/the same during the section S_{F2} at the time domain, while the amplitudes of the section S_{S21} and the section S_{S22} may change with the time t or the sampling number n. In an embodiment, the amplitudes of the section S_{S21} and the section S_{S22} are smaller than that of the section S_{F2}. For example, in terms of a digital form, the amplitude of the section S_{F2} is 1. The amplitudes of the section S_{S21} and the section S_{S22} is less than 1 and even drops to 0.

In an embodiment, the waveform of the section S_{S11} and the section S_{S12} in FIG. 4A or the section S_{S21} and the section S_{S22} in FIG. 4B is defined by a sin-squared function, a linear function, or a rectangular function. For example, the equation (1) for the shaping signal (taking the shaping signal g2 as an example, the shaping signal g1 is a special case where N₀=N₁) is:

$$g 2 ( n ) = \{ \begin{matrix}{sin}^{2} ( \frac{π}{2 {N}_{0}} n ) , & 0 \leq n < {N}_{0} \\ 1 , & {N}_{0} \leq n < N - {N}_{1} - 1 \\ {sin}^{2} ( \frac{π}{2 {N}_{1}} ( N - 1 - n ) , & N - {N}_{1} - 1 \leq n < N\end{matrix} . \qquad ( 1 )$$

where 0 to N₀−1 (i.e., 0≤n<N₀) corresponds to the period of the section S_{S21}, and N₀ to N−N₁−2 (i.e., N₀≤n<N_{c}−N₁−1) corresponds to the period of the section S_{F1}, and N_{C}−N₁−1 to N₁−1 (i.e., N_{c}−N₁−1≤n<N) corresponds to the period of the section S_{S22}. The section S_{S21} and the section S_{S22} are defined by sin²( ) (i.e., sin-squared function).

As another example, the equation (2) for the shaping signal (taking the shaping signal g2 as an example, the shaping signal g1 is a special case where N₀=N₁) is:

$$g 2 ( n ) = \{ \begin{matrix}\frac{n}{{N}_{0}} , & 0 \leq n < {N}_{0} \\ 1 , & {N}_{0} \leq n < N - {N}_{1} - 1 \\ \frac{N - 1 - n}{{N}_{1}} , & N - {N}_{1} - 1 \leq n < N\end{matrix} . \qquad ( 2 )$$

where the section S_{S21} and the section S_{S22} are defined by linear function. For example, the section S_{S21} is a linear function with a slope equal to 1/N₀; the section S_{S22} is a linear function with a slope of −1/N₁ and an intercept with a sampling number axis of 1−N_{c}.

As another example, the equation (3) for the shaping signal (taking the shaping signal g2 as an example, the shaping signal g1 is a special case where N₀=N₁) is:

$$g 2 ( n ) = \{ \begin{matrix}{r}_{0} , & 0 \leq n < {N}_{0} \\ 1 , & {N}_{0} \leq n < N - {N}_{1} - 1 \\ {r}_{1} , & N - {N}_{1} - 1 \leq n < N\end{matrix} . \qquad ( 3 )$$

where r₀ and r₁ are constants from 0 to 1. The section S_{S21} and the section S_{S22} are defined by rectangular function. For example, the amplitude of the section S_{S21} is maintained at r₀ and the amplitude of the section S_{S22} is maintained at r₁.

It should be noted that the mathematical expression of the shaping signal is not limited to the aforementioned equations (1)˜(3), and the parameter and/or the type of the function is changed according to the needs of the user. In an embodiment, the amplitude of the section S_{F1}/S_{F2} is nearly around a constant (for example, 1), however, an integral of the shaping signal g1(n)/g2(n) on an interval length (for example, sampling number is No) within the section S_{S11}/S_{S21} or the section S_{S12}/S_{S22} is less than an integral of the shaping signal g1(n)/g2(n) on the same interval length within the section S_{F1}/S_{F2}.

Referring to FIG. 2, the transmitting front-end circuit 12 is coupled to the frequency synthesizer 111 and the signal generator 112, and is configured to generate a transmitting signal according to the carrier signal (e.g., the carrier signal x1 of FIG. 3A, the carrier signal x2 of FIG. 3B, or other FMCW signals) and the shaping signal (e.g., the shaping signal g1 in FIG. 4A, the shaping signal g2 in FIG. 4B, or other shaping signals). The transmitting signal is emitted by the radar apparatus 10.

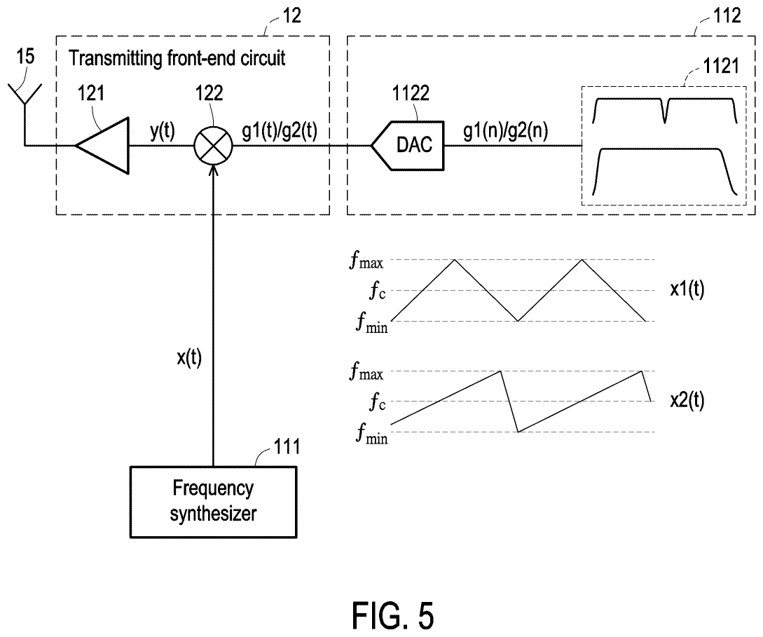

Specifically, FIG. 5 is a schematic diagram of a transmitting front-end circuit 12, an input signal thereof, a frequency synthesizer 111, and a signal generator 112 according to an embodiment of the disclosure. Referring to FIG. 5, the radar apparatus 10 includes an antenna 15. The signal generator 112 includes a wave generator 1121 and a digital to analog converter (DAC) 1122. The wave generator 1121 is configured to generate an initial shaping signal. For example, the shaping signal g1(n) in FIG. 4A, the shaping signal g2(n) in FIG. 4B, or other digital form shaping signals. The digital to analog converter 1122 is coupled to the wave generator 1121. The digital to analog converter 1122 is configured to convert the initial shaping signal into a shaping signal in analog form. For example, the shaping signal g1(t) in FIG. 4A, the shaping signal g2(t) in FIG. 4B, or other shaping signals in analog form. In some embodiments, in response to the wave generator 1121 generating a shaping signal in analog form, the digital to analog converter 1122 is omitted.

The transmitting front-end circuit 12 may include an amplifier 121 and a mixer 122. The amplifier 121 is coupled to the antenna 15. The mixer 122 is coupled to the frequency synthesizer 111 and the digital to analog converter 1122. The mixer 122 is configured to mix the carrier signal x(t) and the shaping signal g1(t) or the shaping signal g2(t) to generate a mixed signal y(t). That is, the carrier signal x(t) and the shaping signal g1(t) or the shaping signal g2(t) are input signals of the transmitting front-end circuit 12. The carrier signal x(t) is, for example, the carrier signal x1(t) in FIG. 3A, the carrier signal x2(t) in FIG. 3B, or other FMCW signals. A maximum frequency fₘₐₓ of the carrier signal x1(t) and the carrier signal x2(t) may be f_{c}+B/2, and the minimum frequency fₘᵢₙ thereof may be f_{c}−B/2.

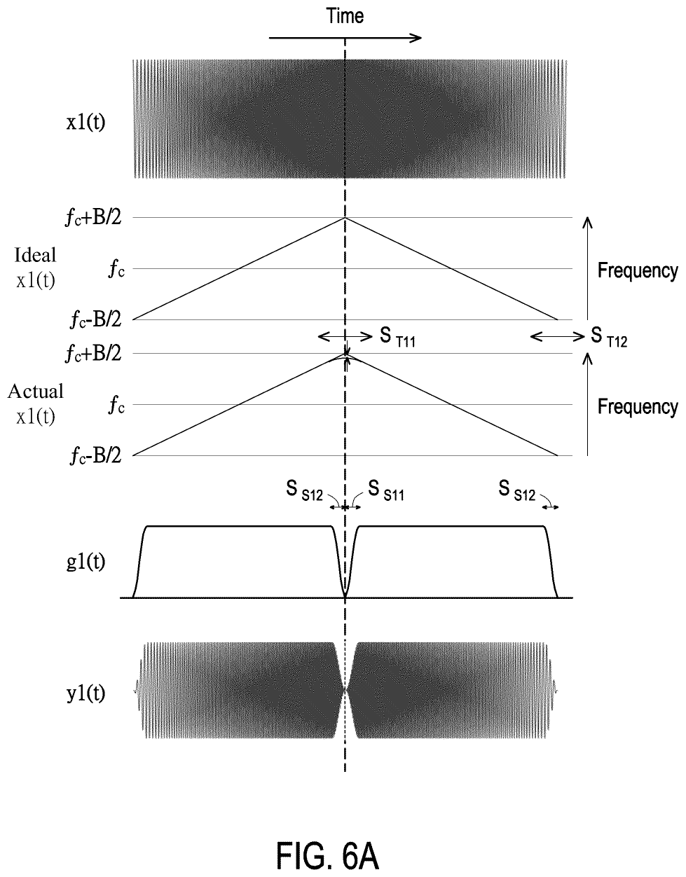

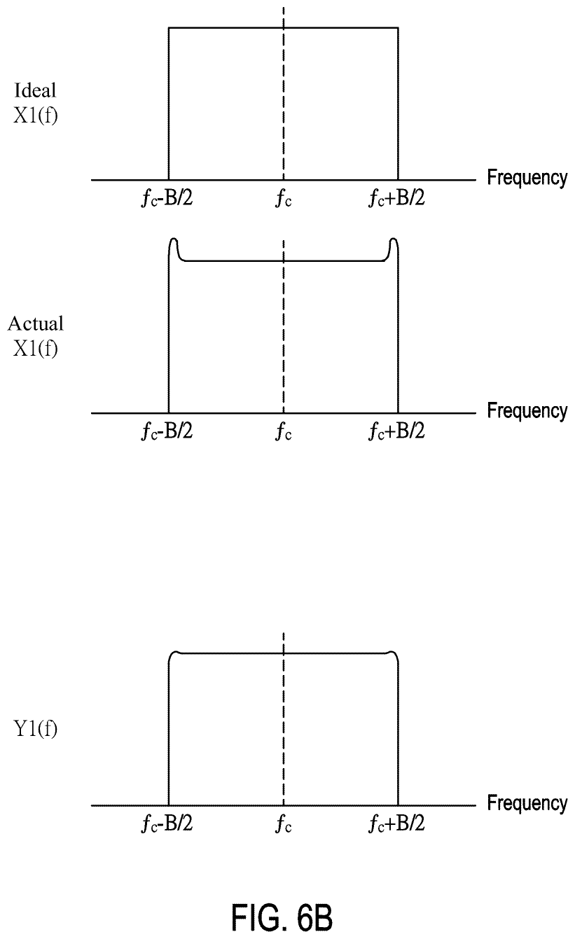

FIG. 6A is a schematic diagram of a waveform according to an embodiment of the disclosure. Referring to FIG. 6A, under ideal situations, the turn-around section S_{T11} of the triangle wave shaping signal x1 is a period where the signal rises linearly to the peak of the waveform and decreases linearly to the valley of the waveform. However, in actual situations, the shaping signal x1 may change slowly in the turn-around section S_{T11} and be difficult to reach f_{c}+B/2. Alternatively, the turn-around section S_{T12} may change slowly and be difficult to reach f_{c}−B/2.

FIG. 6B is a schematic diagram according to the spectrum of FIG. 6A. Referring to FIG. 6B, under ideal situations, the intensity of the carrier signal X1(f) from f_{c}−B/2 to f_{c}+B/2 in the frequency domain is the same. However, in actual situations, the frequency of the carrier signal X1(f) has a higher intensity near f_{c}−B/2 and f_{c}+B/2.

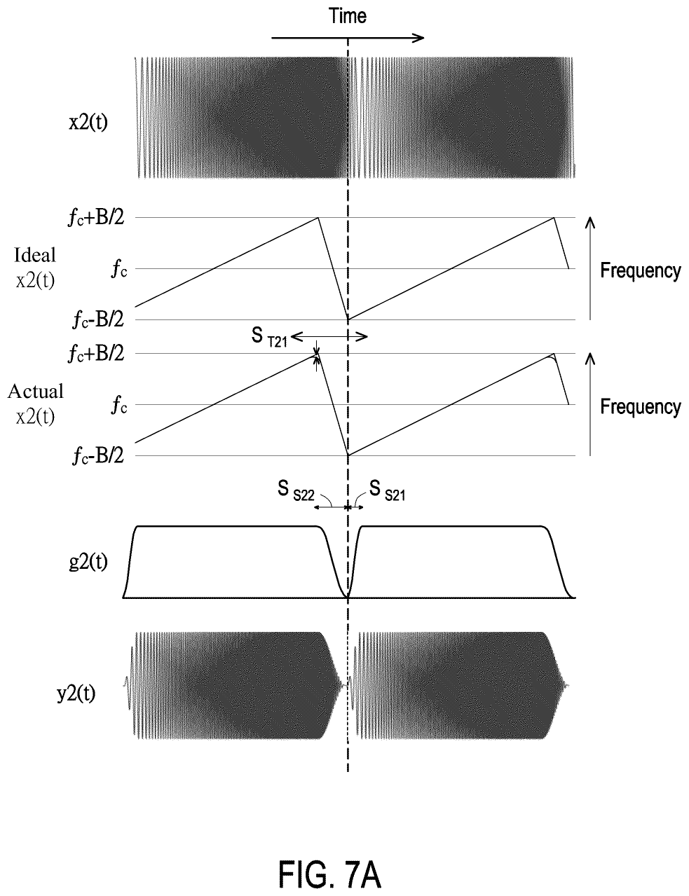

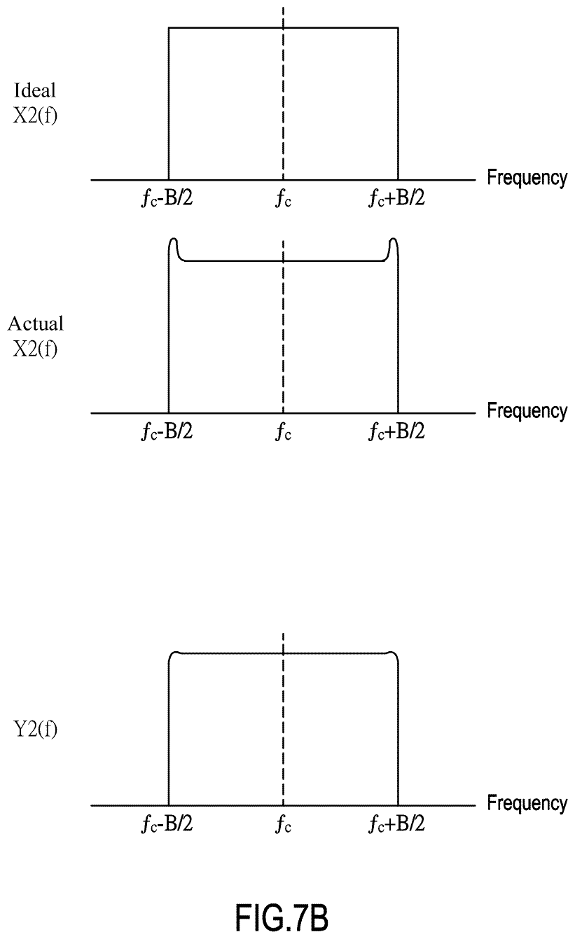

FIG. 7A is a schematic diagram of a waveform according to an embodiment of the disclosure. Under ideal situations, the turn-around section S_{T21} of the sawtooth wave shaping signal x2 is a period where the signal rises linearly to the peak of the waveform, decreases linearly to the valley of the waveform, and then rises toward the peak of the waveform. However, in actual situations, the shaping signal x2 may change slowly in the turn-around section S_{T21} and be difficult to reach f_{c}+B/2. Alternatively, the turn-around section S_{T22} may change slowly and be difficult to reach f_{c}−B/2.

FIG. 7B is a schematic diagram according to the spectrum of FIG. 7A. Referring to FIG. 6B, under ideal situations, the intensity of the carrier signal X2(f) from f_{c}−B/2 to f_{c}+B/2 in the frequency domain is the same. However, in actual situations, the frequency of the carrier signal X2(f) has a higher intensity near f_{c}−B/2 and f_{c}+B/2.

The spurious peak of the higher intensity may be limited by the emission regulations of some radio frequency bands (e.g., ultra-wideband, UWB), so the transmission power must be reduced, thereby affecting the sensing range of the FMCW radar. The shaping signal is configured to correct/reduce the spurious peak of the carrier signal on the spectrum in actual situations.

Referring to FIG. 3A and FIG. 6A, the section S_{S12} and the section S_{S11} of the shaping signal g1 correspond to the turn-around section S_{T11} at the junction between the frequency raising section S_{R1} and the frequency decreasing section S_{D1} of the carrier signal x1. Similarly, the section S_{S12} and the section S_{S11} of the shaping signal g1 correspond to the turn-around section S_{T12} at the junction between the frequency decreasing section S_{D1} and the frequency raising section S_{R1} of the carrier signal x1. It should be noted that “corresponding” here means that the periods of the section S_{S12} and the section S_{S11} are approximately the same as the turn-around section S_{T11}, or the periods of the section S_{S12} and the section S_{S11} are approximately the same as the turn-around section S_{T12}.

Referring to FIG. 5 and FIG. 6A, the mixer 122 of the transmitting front-end circuit 12 may mix the shaping signal g1(t) and the carrier signal x1(t) (i.e., the product of the two time domain signals) to generate a mixed signal y(t) (i.e., the mixed signal y1(t) of FIG. 6A). Referring to FIG. 6B, in terms of spectrum, the frequency of the mixed signal Y1(f) has no obvious spurious peak near f_{c}−B/2 and f_{c}+B/2 and approaches the ideal carrier signal X1(f).

Referring to FIG. 3B and FIG. 7A, the section S_{S22} and the section S_{S21} of the shaping signal g2 correspond to the turn-around section S_{T21} (corresponding to the peak and the valley of the waveform) at the interval from the frequency raising section S_{R2} to the frequency decreasing section S_{D2} of the carrier signal x2. It should be noted that “corresponding” here means that the periods of the section S_{S22} and the section S_{S21} are approximately the same as the turn-around section S_{T21}.

Referring to FIG. 5 and FIG. 7A, the mixer 122 of the transmitting front-end circuit 12 mixes the shaping signal g2(t) and the carrier signal x2(t) to generate a mixed signal y(t) (i.e., the mixed signal y2(t) of FIG. 7A). Referring to FIG. 7B, in terms of spectrum, the frequency of the mixed signal Y2(f) has no obvious spurious peak near f_{c}−B/2 and f_{c}+B/2 and approaches the ideal carrier signal X2(f).

Referring to FIG. 5, the amplifier 121 amplifies the mixed signal y(t) to generate the transmitting signal. The antenna 15 emits the transmitting signal (e.g., the amplified mixed signal y(t)).

In an embodiment, the radar apparatus 10 may further include a receiving circuit (not shown). The receiving circuit may receive an echo signal generated by the transmitting signal reflected by an object, and determine an existence, a distance, and/or a velocity of the object accordingly. For example, the receiving circuit includes an antenna, a low noise amplifier, and a mixer.

Referring to FIG. 2, the controller 13 is coupled to the frequency synthesizer 111 and the signal generator 112. The controller 13 is configured to synchronize the section S_{S11} and the section S_{S12} of the shaping signal g1 of FIG. 4A with the turn-around section S_{T11} and the turn-around section S_{T12} between the frequency raising section S_{R1} and the frequency decreasing section S_{D1} of the carrier signal x1 in FIG. 3A on a timeline; or to synchronize the section S_{S21} and the section S_{S22} of the shaping signal g2 of FIG. 4B with the turn-around section S_{T21} between the frequency raising section S_{R2} and the frequency decreasing section S_{D2} of the carrier signal x2 of FIG. 3B, or synchronize the section that has different amplitude among other shaping signals with the turn-around section between the frequency raising section and the frequency decreasing section of other FMCW signals. For example, through the wave generator 1121 in FIG. 5, the characteristic of quickly adjusting the amplitude of the signal is realized, and the two signals are synchronized through a clock signal (not shown). In response to the waveform of the carrier signal x1 that entering the turn-around section being detected by the controller 13, the controller 13 drives the signal generator 112 to convert a rectify signal into the section S_{S11} and the section S_{S12} of FIG. 4A or the section S_{S21} and the section S_{S22} of FIG. 4B in the period of the turn-around section.

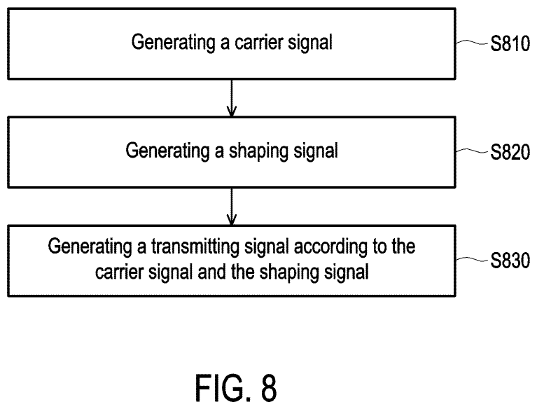

FIG. 8 is a flowchart of a signal processing method for radar apparatus 10 according to an embodiment of the disclosure. Referring to FIG. 2 and FIG. 8, a carrier signal is generated (step S810). A frequency of the carrier signal changes with time within a sweep period of the carrier signal, and the carrier signal includes a frequency raising section and a frequency decreasing section, such as the frequency raising section S_{R1} and the frequency decreasing section S_{D1} of the carrier signal x1 in FIG. 3A, and the frequency raising section S_{R2} and the frequency decreasing section S_{D2} of carrier signal X2 in FIG. 3B. A shaping signal is generated (step S820). The shaping signal includes two sections. The amplitude of a certain section (e.g., the section S_{F1} of FIG. 4A and the section S_{F2} of FIG. 4B) is different from that of another section (e.g., the section S_{S11} and the section S_{S12} of FIG. 4A and the section S_{S21} and the section S_{S22} of FIG. 4B). The another section corresponds to the turn-around section (e.g., the turn-around section S_{T11} and the turn-around section S_{T12} in FIG. 3A and the turn-around section S_{T21} in FIG. 3B) between the frequency raising section and the frequency decreasing section. A transmitting signal is generated according to the carrier signal and the shaping signal (step S830). The transmitting signal is configured to allow the radar apparatus 10 to emit.

The implementation details of each of the steps in FIG. 8 have been described in detail in the aforementioned embodiments and implementation method, and will not be repeated herein. In addition to being implemented in the form of a circuit, the steps and implementation details of the embodiment of the disclosure is also implemented by a processor in the form of a software, which is not limited by the embodiments of the disclosure.

To sum up, in the radar apparatus, the signal processing circuit, and the signal processing method for radar apparatus of the embodiments of the disclosure, the carrier signal is corrected by the shaping signal to reduce the spurious peak of the transmitting signal on the spectrum. In this way, it may comply with the emission regulations of UWB or other wireless technologies and maintain the sensing range.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A radar apparatus, comprising:
a frequency synthesizer, configured to generate a carrier signal, wherein a frequency of the carrier signal changes with time within a sweep period of the carrier signal, and the carrier signal comprises a frequency raising section and a frequency decreasing section;
a signal generator, configured to generate a shaping signal, wherein the shaping signal comprises a first section and a second section, the first section and the second section have different amplitudes, and the second section corresponds to a turn-around section between the frequency raising section and the frequency decreasing section; and
a transmitting front-end circuit, coupled to the frequency synthesizer and the signal generator and configured to generate a transmitting signal according to the carrier signal and the shaping signal.

2. The radar apparatus according to claim 1, wherein the carrier signal is a triangle wave, and the turn-around section corresponds to a junction between the frequency raising section and the frequency decreasing section.

3. The radar apparatus according to claim 1, wherein the carrier signal is a sawtooth wave, and the turn-around section corresponds to an interval from the frequency raising section to the frequency decreasing section.

4. The radar apparatus according to claim 1, wherein an amplitude of the second section is smaller than the first section.

5. The radar apparatus according to claim 1, wherein a waveform of the second section is defined by a sin-squared function, a linear function, or a rectangular function.

6. The radar apparatus according to claim 1, wherein an amplitude is the same during the first section at a time domain.

7. The radar apparatus according to claim 1, wherein the transmitting front-end circuit comprises:
a first mixer, coupled to the signal generator and the frequency synthesizer and configured to mix the carrier signal and the shaping signal to generate a mixed signal; and
a first amplifier, coupled to a first antenna and configured to amplify the mixed signal to generate the transmitting signal, and the radar apparatus further comprising:
the first antenna, coupled to the first amplifier and configured to emit the transmitting signal.

8. The radar apparatus as according to claim 1, further comprising:
a controller, coupled to the signal generator and the frequency synthesizer and configured to synchronize the second section to the turn-around section between the frequency raising section and the frequency decreasing section.

9. The radar apparatus according to claim 1, wherein the signal generator comprises:
a wave generator, configured to generate an initial shaping signal; and
a digital to analog converter, coupled to the wave generator and configured to convert the initial shaping signal into the shaping signal.

10. The radar apparatus according to claim 1, wherein the radar apparatus is an ultra wideband (UWB) radar.

11. A signal processing circuit, comprising:
a frequency synthesizer, configured to generate a carrier signal, wherein a frequency of the carrier signal changes with time within a sweep period of the carrier signal, and the carrier signal comprises a frequency raising section and a frequency decreasing section; and
a signal generator, configured to generate a shaping signal, wherein the shaping signal comprises a first section and a second section, the first section and the second section have different amplitudes, and the second section corresponds to a turn-around section between the frequency raising section and the frequency decreasing section.

12. A signal processing method for a radar apparatus, comprising:
generating a carrier signal, wherein a frequency of the carrier signal changes with time within a sweep period of the carrier signal, and the carrier signal comprises a frequency raising section and a frequency decreasing section;
generating a shaping signal, wherein the shaping signal comprises a first section and a second section, the first section and the second section have different amplitudes, and the second section corresponds to a turn-around section between the frequency raising section and the frequency decreasing section; and
generating a transmitting signal according to the carrier signal and the shaping signal, wherein the transmitting signal is configured to allow the radar apparatus to emit.

13. The signal processing method for the radar apparatus according to claim 12, wherein the carrier signal is a triangle wave, and the turn-around section corresponds to a junction between the frequency raising section and the frequency decreasing section.

14. The signal processing method for the radar apparatus according to claim 12, wherein the carrier signal is a sawtooth wave, and the turn-around section corresponds to an interval from the frequency raising section to the frequency decreasing section.

15. The signal processing method for the radar apparatus according to claim 12, wherein an amplitude of the second section is smaller than the first section.

16. The signal processing method for the radar apparatus according to claim 12, wherein a waveform of the second section is defined by a sin-squared function, a linear function, or a rectangular function.

17. The signal processing method for the radar apparatus according to claim 12, wherein an amplitude is the same during the first section at a time domain.

18. The signal processing method for the radar apparatus according to claim 12, further comprising:
synchronizing the second section with the turn-around section between the frequency raising section and the frequency decreasing section.

19. The signal processing method for the radar apparatus according to claim 12, further comprising:
generating an initial shaping signal; and
converting the initial shaping signal from a digital form to an analog form of the shaping signal.
